(19) United States
(12) Patent Application Publication
(10) Pub. No.: US 2024/0376727 A1
(43) Pub. Date: Nov. 14, 2024

(54) SCAFFOLD TRANSOM

(71) Applicant: PERI SE, Weissenhorn (DE)

(72) Inventor: Tobias Steck, Weissenhorn (DE)

(73) Assignee: PERI SE, Weissenhorn (DE)

(21) Appl. No.: 18/686,933

(22) PCT Filed: Aug. 12, 2022
(86) PCT No.: PCT/EP2022/072652

§ 371 Date: Feb. 27, 2024

(30) Foreign Application Priority Data
Aug. 27, 2021 (DE) 102021122295.8

(51) Int. Cl. E04G 7/34; E04G 1/04; E04G 5/00; E04G 5/06; E04G 7/30; F16B 7/04

(52) U.S. Cl. CPC E04G 7/34; E04G 1/04; E04G 5/007; E04G 5/067; E04G 7/305; F16B 7/0473

(57) ABSTRACT

A scaffold transom, particularly for the horizontally oriented installation in a scaffold section, the scaffold transom comprising at least one transom support which is rod-shaped and extends in the direction of a longitudinal axis, the transom support having two opposing ends in the direction of the longitudinal axis, and a connection interface being located at each of these two ends, which connection interface is provided for the connection to a scaffold element, at least two brackets which each extend along a bracket axis, the brackets each having two opposing ends in the direction of their bracket axis, one of said ends of each bracket being connected to the transom support, and at least two closures respectively one of which is located at the end of a bracket opposite of the connection of said bracket to the transom support.

### FIELD

The invention relates to a scaffold transom, in particular for the horizontally oriented installation in a scaffold section, said scaffold transom comprising: at least one transom support which is rod-shaped and extends in the direction of a longitudinal axis, the transom support having two opposing ends in the direction of the longitudinal axis, and a connection interface being located at each of these two ends which connection interface is provided for connection to a scaffold element, at least two brackets which respectively extend along a bracket axis, the brackets respectively having two opposing ends in the direction of their bracket axis, one of said ends of each bracket being connected to the transom support, and at least two closures respectively one of which is located at the end of a bracket opposite of the connection of said bracket to the transom support. The invention further relates to a scaffold section comprising a scaffold transom, as well as to a method for constructing such a scaffold section.

### BACKGROUND

Scaffolds are used for various functions in the construction sector. Facade scaffolds serve to shape, for example, to paint the outer surfaces of buildings. Facade scaffolds are typically assembled from facade scaffold frames as the main components, in recent times they are also assembled from modular scaffolds. In civil engineering, support scaffolds are used to get a wide variety of building parts into position and to keep them there. Such building parts may be, for example, precast concrete elements, steel beams or steel structures. Moreover, elements required for the erection of buildings such as temporary structures or formwork can be positioned with the aid of support scaffolds. Finally, scaffolds are also made use of in the service or revision sector, for example, to safely get personnel to the plant sections to be revised in large process plants such as refineries. Principally, for scaffolds, the basic requirements prevail that they have to be readily transportable and easy to assemble.

Numerous scaffolds have a modular structure which means that various shapes and sizes of scaffolds can be assembled from standard components based on a modular concept. Commonly, there are standard components which are mainly deployed in a vertical orientation when a scaffold is assembled, and other standard components which are mainly used in a horizontal orientation. Vertically oriented standard components are usually referred to as vertical posts or scaffold posts. The horizontally oriented components connectable to these are often referred to as horizontal transoms or scaffold transoms. When a scaffold or a scaffold section is assembled a plurality of scaffold posts are oriented parallel to each other and then connected to a plurality of horizontal transoms oriented perpendicular thereto. The connection of the scaffold elements is established through interfaces. In this way, scaffolds or scaffold sections comprising a plurality of levels can be assembled in an easy way.

There are applications in which a scaffold section or a scaffold level is subjected to a higher load than usual. This may be the case, for example, in a scaffold section located in a lower level of a scaffold on which, above it, a plurality of other levels is arranged. A higher load may also occur when the scaffold or the scaffold section are to support and position building parts or other components having a high weight. In case of such a higher load, the scaffold sections are particularly subjected to higher bending loads. In known modular scaffolds, there is the option to install additional standard components as struts in such cases to compensate higher bending loads. This is usually achieved by installing a plurality of scaffold transoms extending parallel to each other in the horizontal direction between vertically oriented scaffold elements. Problematic in this solution is that the number of the connection interfaces for installing additional struts on the scaffold elements oriented in the vertical direction is limited. It is therefore not always possible to increase the load capacity of a scaffold section by the further installation additional of horizontally oriented scaffold elements since, in some cases, no free connection interfaces for installing additional scaffold elements are provided. In such a case, an increased load capacity can only be obtained by using another scaffold system having a higher load capacity which involves increased effort and higher costs.

### SUMMARY

The object of the invention is therefore to propose solutions with the aid of which the load capacity, particularly the bending strength of a scaffold having a modular design can be increased while the number of the required scaffold elements is to remain the same.

This object of the invention is solved by a scaffold transom, in particular for the horizontally oriented installation in a scaffold section, comprising:
at least one transom support which is rod-shaped and extends in the direction of a longitudinal axis, the transom support having two opposing ends in the direction of the longitudinal axis, and a connection interface being located at each of these two ends which connection interface is provided for the connection to a scaffold element,
at least two brackets which respectively extend along a bracket axis, the bracket axes being respectively oriented at an angle of 1° to 89° to the longitudinal axis, and the brackets respectively having two opposing ends in the direction of their bracket axis, one of these ends of each bracket being connected to the transom support,
at least two closures respectively one of which is located at the end of a bracket opposite of the connection of this bracket to the transom support,
each closure comprising a housing fixedly connected to the bracket and each closure further comprising a connecting element supported so that it is movable relative to the housing,
the connecting element comprising at least one retaining portion and one guide portion, the retaining portion and the guide portion being arranged adjacent to each other and adjoining one another in the direction of a closure axis, the retaining portion comprising a head and a shaft which are arranged adjacent to each other and adjoining one another in the direction the closure axis, and the head, at least in sections, projecting beyond the shaft in the radial direction to the closure axis, the head being provided for establishing a positive connection to a scaffold element, and
each closure comprising at least one clamping element which is movably, particularly positively connected to the housing and the connecting element, a movement of the clamping element relative to the housing moving the connecting element relative to the housing in the direction of the closure axis, the two connection interfaces of the at least one transom support and the two closures together providing for at least four connection points for the connection of the scaffold transom to other scaffold elements and the connection interfaces being different from the closures with respect to the shape and the size.

A scaffold transom according to the invention comprises altogether four connection points by means of which it can be connected to other scaffold elements. These four connection points are arranged at a distance to each other. In this way, the scaffold transom according to the invention is capable of absorbing larger forces and momentums acting in a scaffold section than known horizontal transoms.

The scaffold transom according to the invention comprises a preferably horizontally installed transom support having a rod-shaped design. This is to be understood to mean that the length of the transom support is substantially larger than its width and thickness. The transom support extends along a longitudinal axis and comprises respectively one connection interface on opposite ends. The transom support comprising the two connection interfaces substantially corresponds to a known horizontal transom. The connection interfaces are provided for the connection to a scaffold element, preferably a vertical post, and formed and dimensioned so that they can be positively and non-positively connected to associated interfaces on the scaffold element. The connection interfaces are configured so that they are compatible with connection interfaces of known horizontal transoms. In this way, the scaffold transom according to the invention can be readily integrated in an existing scaffold system. For increasing the load capacity, particularly in the deflection of forces and momentums, at least two brackets on which respectively one closure is disposed are attached to the transom support. The two closures also serve as a connection point to a scaffold element and are different from the connection interfaces on the transom support with respect to their shape, size, and function. Each of the brackets extends along a bracket axis, each bracket axis being oriented at an angle of 1° to 89° to the longitudinal axis of the transom support. This means that the two brackets extend at an acute angle relative to the transom support. Each bracket has two opposite ends one of which is fixedly connected to the the transom support, and the other one of which is fixedly connected to a closure. The two closures are positioned at a distance to the transom support and its longitudinal axis by the brackets. Preferably, the transom support is attached to a scaffold element by means of a connection interface and a closure. Due to the fact that the connection interfaces and the closure are spaced apart, this connection can transfer forces and momentums in a safe way through two connection points. Each closure comprises a housing which is fixedly and immovably connected to a bracket. On the inside of each housing, a connecting element is supported so that it is movable relative housing. Furthermore, each closure comprises a clamping element which, in sections, is also movably introduced into the housing and into the connecting element. The clamping element serves the operation of the closure. When the clamping element is moved, for example in a linear and/or rotational movement, this movement is translated into a movement of the connecting element relative to the stationary housing. This movement of the connecting element can be used to establish or release a connection between the closure and a scaffold element. The connecting element comprises a retaining portion and a guide portion which are arranged adjacent to each other. The connecting element extends along a closure axis. Incidentally, the support of the connecting element in the housing is configured so that the connecting element is shiftable relative to the housing along the closure axis and rotatable about the closure axis. The retaining portion comprises a head which is provided for the positive connection to a scaffold element. The head is connected to the retaining portion through a shaft. Here, the head is configured so that it projects beyond the shaft on at least one side in the radial direction to the closure axis. This projection can be used for establishing a positive connection to a scaffold element as described later. Preferably, the head projects radially beyond the shaft in two opposite directions. The clamping element is, in sections, inserted into the connecting element and the housing, however, the clamping element is also supported so that it is movable relative to the connecting element and to the housing. When the scaffold transom is in use, the clamping element is moved by an operator, and the closure is operated thereby. With a movement of the clamping element, the connecting element inside the stationary housing is moved so that a connection between the head and a scaffold element can be established and released. Each closure is therefore provided as a connection point to a scaffold element.

Therefore, the scaffold transom according to the invention comprises altogether four connection points, two of which are formed by known connection interfaces, and two additional ones are formed by respectively one closure which is arranged at a distance to the connection interfaces. With these four connection points by means of which the scaffold transom according to the invention can be connected in a scaffold section the transferability of forces and momentums by the scaffold transom is significantly improved as compared to a known horizontal transom. Particularly, the spaced-apart arrangement of the connection points renders a considerably improved transfer of momentums possible. In this way, a single scaffold transom according to the invention can transfer considerably more forces and momentums without additional interfaces being required for connecting the known connection interfaces. Therefore, the use of a scaffold transom according to the invention in a scaffold section can improve its load capacity without an increase in the number of elements in the scaffold section. Another advantage of a scaffold transom according to the invention is that existing and known interfaces on other scaffold elements can still be used. The scaffold transom according to the invention is therefore readily integrable into existing scaffold systems. Moreover, the scaffold transom has a simple and compact design, and the closures provided according to the invention can be easily and ergonomically operated. The design of the scaffold transom including its base transom and the two brackets connected thereto at an angle requires considerably less space in a scaffold section than the parallel arrangement of two known horizontal transoms which may also be used for increasing the load capacity of a scaffold section. Therefore, a scaffold transom according to the invention will interfere with workers and work on the scaffold section to a considerably lesser extent than the enhancement of the load capacity of a scaffold section by means of two horizontal transoms arranged parallel to each other.

In one embodiment, it is contemplated that the connecting element is supported in the housing so that it is axially shiftable relative to the closure axis and rotatable about the closure axis. In this embodiment, the connecting element is linearly and rotationally movable relative to the housing. This renders an advance movement towards a scaffold element and an interlock in a scaffold element possible.

Furthermore, it is contemplated that the closure axis is oriented parallel to the longitudinal axis. In this embodiment, the connection between closure and a scaffold element is preferably established in a horizontal direction. In this way, the connection of the closure to the scaffold element can be established when a connection interface of the transom support is already connected to the scaffold element.

Skilfully, it is contemplated that the connecting element is movably supported in the housing by a plain bearing. In this embodiment, there is a plain bearing between the housing and the connecting element and/or between the connecting element and the clamping element. This plain bearing may be supported by adding a lubricant such as, for example, grease.

Advantageously, it is contemplated that the guide portion, at least in sections, has a cylindrical design, and that, in the housing, at least in sections, a cylindrical cavity is incorporated, the inner diameter of the cylindrical cavity being larger than the outer diameter of the cylindrical portion of the guide portion, and a clearance fit being established between the cylindrical cavity and the guide portion, and the connecting element, at least in sections, being arranged inside the housing. In this embodiment, there is a clearance fit between the interior of the housing and the outside of the guide portion of the connecting element. This clearance fit allows for an easy installation and operation of the closure.

In one embodiment, it is contemplated that the connecting element is longer than the housing in the direction of the closure axis. Consequently, the connecting element will always project beyond the housing on at least one side and can therefore always be grabbed and moved by an operator. In this way, an introduction of force by hammer blows onto an end of the connecting element is also possible.

Furthermore, it is contemplated that a clamping element receptacle implemented as an opening extending through the guide portion in the radial direction to the closure axis is provided in the guide portion. This clamping element receptacle accommodates the clamping element, at least partly, in the mounted state of the closure. Preferably, the clamping element receptacle is configured as an opening in the guide portion extending radial to the closure axis and has a rectangular surface in the cross section. The size and the position of the clamping element receptacle are selected so that the clamping element can be moved in it with a clearance fit in the opened state described later but abuts on at least one surface of the clamping element receptacle in the locked state described later.

Advantageously, it is contemplated that the cross-sectional area of the clamping element receptacle is implemented so that its size varies in a direction radial to the closure axis. This is to be understood to mean that the shape of the clamping element receptacle continuously changes along a direction radial to the closure axis. Preferably, at least one boundary surface of the clamping element receptacle is oriented at an angle to a plane perpendicular to the closure axis here. In this way, an associated counter form to a clamping element implemented in a wedge-shape is provided. With a wedge shape of the clamping element and/or the clamping element receptacle, a translation of a movement of the clamping element directed perpendicular to the closure axis into a movement of the connecting element directed parallel to the closure axis can be provided for. Preferably, the cross-sectional area of the clamping element receptacle on an outer side of the guide portion is larger on the opposite outer side of the guide portion, the cross-sectional area varying linearly between these two outer sides.

Preferably, it is contemplated that, on the guide portion, on its side facing away from the connection portion in the direction of the closure axis, a force introduction surface is disposed which, at least in sections, is oriented perpendicular to the closure axis. Such a force introduction surface can be used to directly apply a force to the connecting element and to thereby move it relative to the housing along the closure axis. In this way, the connecting element can be moved in the housing even without an operation of the clamping element. The operability of the closure is therefore further facilitated by the provision of a force introduction surface.

Furthermore, it is contemplated that the shaft has a cylindrical cross section which is substantially oriented perpendicular to the closure axis. Such a cylindrical configuration of the shaft renders a compact and stable design of the retaining portion possible. Moreover, a cylindrical shaft has no sharp edges which might cause collisions when the closure is connected to a scaffold element.

It is contemplated that the shaft connects the guide portion to the head. The shaft is therefore disposed between the head and the cylindrical portion of the guide portion.

Furthermore, it is contemplated that the head comprises a curved contact surface directed towards the guide portion in its portion projecting beyond the shaft. In this embodiment, a curved contact surface which, when the closure is connected to a scaffold element, abuts on the inside of this scaffold element is provided on the head. This curved contact surface is disposed on the side of the head facing the shaft and the guide portion. Such a curved contact surface is particularly advantageous for the abutment on a scaffold element also having a curved design. The curved contact surface may also be implemented in two parts, the two parts of the curved contact surface being disposed on opposite sides of the closure axis. Such a configuration in two parts ensures a symmetrical flow of forces between the head and a scaffold element connected thereto which renders the transfer of large forces and momentums possible.

Preferably, it is contemplated that the curved contact surface constitutes part of a circumferential surface of a circular cylinder. This embodiment is particularly advantageous when the interior of a scaffold element which the curved contact surface of the head abuts on when the closure is connected to scaffold element also has the shape of a circumferential surface of a circular cylinder.

In an advantageous implementation, it is contemplated that the connecting element has an imaginary head plane extending along the closure axis and bisecting the guide portion, the head projecting beyond the shaft on both sides of the closure axis in the head plane. In this embodiment, an imaginary head plane defines a plane extending through the connecting element. This head plane is oriented parallel to the closure axis and bisects the guide portion in the radial direction to the closure axis. The head plane intersects the head so that, within the head plane, the head projects beyond the shaft on both sides in a direction perpendicular to the closure axis. Preferably, the head plane is oriented so that it intersects the head where it projects the furthest beyond the shaft in the radial direction to the closure axis.

Furthermore, it is favourably contemplated that the curved contact surface is at least partly formed by a part of a circumferential surface of a circular cylinder, the central axis of the circular cylinder being oriented perpendicular to the head plane. In this embodiment, the axis of curvature of the curved contact surface extends perpendicular to the head plane. When, during the establishment of a connection, the head is brought into abutment on the inside of a scaffold element, the head plane is oriented perpendicular to the longitudinal axis of the scaffold element. Therefore, the axis of curvature of the curved contact surface will then extend parallel to or even congruent with the longitudinal axis of the scaffold element. Since the inner surface of the scaffold element preferably corresponds to the circumferential surface of a circular cylinder, an extensive abutment of the curved contact surface on the inside of the scaffold element is ensured in this embodiment. Due to the fact that both the contact surface and the inner surface of the scaffold element have the shape of a part of a circular cylinder, also a positive connection of the head to the scaffold element is given.

Furthermore, it is contemplated that the head is formed so that it is symmetrical with respect to the head plane. In this embodiment, the head extends on both sides of the head plane and is designed so as to be symmetrical with respect to the same. Preferably, the outer surfaces of the head extend parallel to the head plane on both sides of the head plane.

Preferably, it is contemplated that the head is thinner in a direction perpendicular to the head plane than in a direction in the head plane and perpendicular to the closure axis. In this embodiment, the dimension of the head perpendicular to the head plane is smaller than inside the head plane and perpendicular to the closure axis. For a positive connection of the connecting element to a scaffold element, the projection of the head inside the head plane perpendicular to the closure axis is of paramount importance since an abutment of the head on the inside of the scaffold element takes place in this direction. The larger the contact surface between the head and the scaffold element is, the larger are the forces and momentums which can be transferred through this abutment.

Furthermore, it is contemplated that the head is formed so that it is symmetrical to the closure axis in the head plane. In this embodiment, the head projects equally far beyond both sides of the closure axis in the head plane. In this way, a symmetrical abutment of the head on the scaffold element inside a scaffold element is possible. Such a symmetrical abutment is particularly favourable for an effective transfer of forces and momentums.

Furthermore, it is contemplated that the clamping element receptacle, at least in sections, extends perpendicular to the head plane. In this embodiment, the direction of extension of the clamping element receptacle, at least in sections, extends through the guide portion perpendicular to the head plane. In this way, a clamping element introduced into the clamping element receptacle is conveniently accessible for an operator even in an opened state in which the head plane is oriented parallel to the longitudinal axis of a scaffold element. Even in this opened state, the clamping element projects laterally beyond the housing and can be accessed and operated manually or with the aid of a hammer in an easy manner and without the risk of a collision with the bracket.

Furthermore, it is contemplated that the clamping element receptacle has a substantially rectangular cross section parallel to the head plane. Such a rectangular shape of the cross section is particularly suitable for receiving a clamping element having a rectangular external shape or a rectangular cross section. Moreover, such a rectangular cross section can be readily introduced into the guide portion.

Preferably, it is contemplated that the clamping element receptacle has at least one angled face oriented at an angle of 0.5° to 45° to a plane oriented perpendicular to the closure axis. In this embodiment, an angled face provided as a contact surface to a wedge-shaped surface of the clamping element is disposed in the clamping element receptacle. This angled face is oriented at an acute angle relative to a plane oriented at the right angle to the closure axis. Preferably, this angle is a few degrees, for example, 1° to 15°. The other boundary surfaces in the clamping element receptacle are preferably oriented perpendicular to the closure axis and/or parallel to a plane oriented perpendicular to the head plane and parallel to the closure axis. The angled face is preferably disposed on the side of the clamping element receptacle facing away from the head.

Furthermore, it is contemplated that the clamping element comprises an imaginary clamping element plane, the clamping element plane extending through the clamping element, the clamping element being particularly structured symmetrically to the clamping element plane in the direction of the thickness, the clamping element, at least in sections, being formed in a wedge-shape in a plan view of the clamping element plane and comprising a wedge-shaped surface defining the clamping element perpendicular to the clamping element plane, and the clamping element further comprising a contact surface defining the clamping element perpendicular to the clamping element plane on a side opposite of the wedge-shaped surface, the clamping surface being oriented at an angle of 0.5° to 45° to the contact surface. The clamping element plane serves to unambiguously describe the clamping element and its interaction with the other elements of the closure. The clamping element plane extends through the clamping element and bisects it in the direction of its thickness. The two largest outer surfaces of the clamping element are oriented parallel and symmetrical to the clamping element plane. In a plan view of this clamping element plane, at least a portion of the clamping element is implemented in a wedge-shape, this portion being defined by a wedge-shaped surface and a contact surface. The wedge-shaped surface is oriented at an angle of 0.5° to 45° to the contact surface. Preferably, this angle corresponds to the angle at which the angled face of the clamping element receptacle is oriented with respect to a plane perpendicular to the closure axis. It is therefore particularly preferable that the angle between the wedge-shaped surface and the contact surface is 1° to 15°. The wedge-shaped surface and the contact surface are disposed opposite to each other and extend perpendicular to the clamping element plane.

In one embodiment, it is contemplated that the clamping element comprises a force introduction portion disposed adjacent to the wedge-shaped surface in a plan view of the clamping element plane, the force introduction portion comprising at least one force introduction surface oriented substantially perpendicular to the contact surface in a plan view of the clamping element plane. This force introduction portion can be used to grab the clamping element or to move it with the aid of a tool, for example a hammer. The force introduction portion is disposed on an end of the wedge-shaped portion. The force introduction portion preferably comprises a planar force introduction surface which is, at least in sections, oriented perpendicular to the contact surface of the clamping element in a plan view of the clamping element plane. In the mounted state of the closure, the force introduction surface is oriented parallel to the closure axis.

Furthermore, it is contemplated that the housing, in its interior, comprises an, at least in sections, cylindrically designed cavity the central axis of which is oriented congruent with the closure axis. Such a cylindrical cavity renders a positionally precise accommodation of the cylindrically shaped section of the guide portion of the connecting element possible.

Preferably, it is contemplated that the housing comprises respectively one opening on two opposite ends in the direction of the closure axis. These openings are preferably shaped and dimensioned so that the connecting element can be introduced into the housing and removed from it through at least one of these openings. In this way, the closure can be readily mounted and even maintained or repaired when required.

Furthermore, it is contemplated that the housing, in its housing wall defining the, at least in sections, cylindrically implemented cavity, comprises an operating opening through which the housing wall extends, the operating opening comprising at least one clamping surface oriented perpendicular to the closure axis and defining the operating opening in the direction of the closure axis on the side facing away from the second closure. In the housing wall, an operating opening is incorporated through which the clamping element is guided through the housing wall into the connecting element. The operating opening is significantly larger than the cross-sectional area of the clamping element. Preferably, the operating opening has an irregularly shaped boundary. A clamping surface oriented perpendicular to the closure axis and preferably having a planar configuration is part of this irregular boundary. This clamping surface defines the operating opening on the side disposed opposite of the second closure disposed on the opposite end of the transom element. In the housing wall, also two operating openings each of which comprises a clamping surface oriented perpendicular to the closure axis may be disposed opposite to each other.

In a preferred implementation, it is contemplated that the operating opening comprises a boundary surface defining the operating opening in the direction of the closure axis on the side facing the second closure, the boundary surface being particularly oriented parallel to the clamping surface. In this embodiment, opposite to the clamping surface, a boundary surface oriented parallel to the clamping surface is provided as a boundary of the operating opening. In the locked state, the clamping surface serves as a contact surface for the clamping element, whereas the boundary surface constitutes an abutment surface for limiting the movement of the clamping element in the opened state.

Furthermore, it is contemplated that the operating opening comprises a slide portion which is part of the boundary of the operating opening, the slide portion connecting the clamping surface to the boundary surface, the slide portion comprising at least one guide surface oriented at an angle of 1° to 89° to the clamping surface, the guide surface being disposed on the side of the operating opening located opposite of the connection of the housing to the bracket. In this embodiment, the boundary surface is connected to the clamping surface by means of a slide portion. This slide portion has the effect that the clamping element abuts on this slide portion and slides along it during a movement parallel to the closure axis, and that, in this way, simultaneously, a rotational movement of the clamping element about the closure axis is produced from the linear movement of the clamping element. To this end, the slide portion comprises at least one guide surface which is oriented at an angle of 89° to 1° to the clamping surface and to the boundary surface. Likewise, a plurality of guide surfaces adjoining one another may also be provided which differ from each other with respect to their angle to the clamping surface and to the boundary surface. Moreover, it is also possible to configure the guide surface so that it is curved. Here, the guide surface is disposed on the side of the operating opening opposite of the bracket and/or on the side of the operating opening facing the head.

Preferably, it is further contemplated that the housing comprises an, at least in sections, curved contact surface the axis of curvature of which is oriented perpendicular to the closure axis and parallel to the bracket on its side facing away from the second closure in the direction of the closure axis. In this embodiment, the housing comprises a contact surface provided for the abutment on the outside of a scaffold element on one of its face sides oriented perpendicular to the closure axis. This contact surface is preferably concavely curved and disposed on the side of the housing facing away from the opposing closure. Likewise, two curved abutment surfaces may be disposed on two sides of the housing disposed opposite of each other around the closure axis. Since the outer surfaces of many scaffold elements are formed as a circular cylinder, the curvature of the contact surface is preferably also implemented in the form of a circumferential surface of a circular cylinder. The contact surface has the effect that the housing, during a connection of the closure to a scaffold element, extensively abuts on the outer surface of the scaffold element. This benefits the transfer of high forces and momentums.

Furthermore, it is contemplated that the connecting element is introduced into the cylindrical cavity on the inside of the housing, the central axis of the cylindrical cavity being oriented congruent to the closure axis, the retaining portion facing away from the second closure. In the mounted state of the closure, the connecting element is introduced into the housing so that the retaining portion including the head faces away from the oppositely disposed closure. The force introduction portion of the connecting element is oriented in the direction of the oppositely disposed closure.

Furthermore, it is contemplated that the clamping element, at least in sections, is introduced into the housing and the connecting element, the clamping element extending through the operating opening and the clamping element receptacle. The clamping element preferably extends radially to the closure axis through both the entire housing and the entire connecting element. To this end, the clamping element is guided through the operating opening in the housing wall and the clamping element receptacle in the connecting element.

It is contemplated that the wedge-shaped surface is oriented parallel to the angled face, and the contact surface is oriented parallel to the clamping surface. When the clamping element is introduced into or mounted in the connecting element and in the housing the wedge-shaped surface of the clamping element is oriented parallel to the angled face of the clamping element receptacle, and/or the contact surface of the clamping element is oriented parallel to the clamping surface of the housing. The abutment or interaction of these surfaces is required to transfer the closure from opened state into the locked state. Of course, this parallel orientation is subject to tolerances: particularly during insertion, there is a clearance between these surfaces so that they are not continuously oriented precisely parallel to each other.

Furthermore, it is contemplated that an opened state of the closure is provided in which the head is located in the interior of the housing, the head plane is oriented substantially parallel to the bracket, and the clamping element projects beyond the connecting element by a first distance, the first distance being the distance between the outer surface of the cylindrical section of the guide portion and the force introduction surface. The opened state is a state in which the closure is not connected to a scaffold element but prepared for such a connection. For connecting the closure to a scaffold element, the closure is transferred from the opened state into the locked state described later. In the opened state, the head is located in the interior of the housing and does not project beyond it. Here, the head plane is oriented substantially parallel to the bracket. This means that the sections of the head projecting beyond the shaft are also oriented parallel to the bracket. Preferably, the scaffold transom is connected to a vertically oriented scaffold element in the opened state. In the opened state, the clamping element projects beyond the connecting element by a first distance. In the opened state, the clamping element abuts on the boundary of the operating opening in a portion of the slide portion. Owing to this abutment produced by gravity acting on the clamping element, the closure is stably positioned in the opened state at a substantially vertical orientation of the bracket. Here, stable means that the closure automatically remains in the open position without a manual operation of the clamping element due to the influence of gravity on the clamping element. This facilitates the positioning of the scaffold transom relative to the scaffold element to which it is to be connected. In the opened state, the connection interface of the transom support is connected to an associated interface on a scaffold element. Preferably, the closure is then already correctly positioned relative to the scaffold element in this connected state to carry out a transfer into the locked state.

Furthermore, a locked state of the closure is provided in which the head projects beyond the housing, the head plane is oriented substantially perpendicular to the bracket, the wedge-shaped surface abuts on the angled face, the contact surface abuts on the clamping surface, and the clamping element projects beyond the connecting element by a second distance, the second distance being the distance between the outer surface of the cylindrical section of the guide portion and the force introduction surface, the second distance being smaller than the first distance. In the locked state, the closure may be connected to a scaffold element. For establishing this connection, the head projects beyond the housing of the closure in the direction of the closure axis in the locked state. Moreover, the head plane is rotated by 90° as compared to the opened state, and therefore oriented substantially perpendicular to the bracket then. Furthermore, the partial surface of the clamping element abuts on the angled face of the clamping element receptacle in the connecting element. Moreover, the contact surface of the clamping element abuts on the clamping surface of the operating opening of the housing. In the locked state, the clamping element is introduced further into the housing and the connecting element, the force introduction surface of the clamping element projecting beyond the surface of the connecting element by a second distance. This second distance is smaller than the first distance in the opened state. In between the opened state and the locked state, of course, a plurality of intermediate states is possible which are assumed by the closure during the transfer.

Furthermore, it is contemplated that the clamping element is slidably supported in the clamping element receptacle. When required, the slidability of the clamping element in the clamping element receptacle may be further improved by the provision of a lubricant, for example, grease.

It is contemplated that, during a transfer of the scaffold transom from the opened state into the locked state, the connecting element is linearly moved away from the second closure in the direction of the closure axis, and the connecting element is rotated about the closure axis, particularly rotated by an angle of substantially 90°. The transfer of the closure from the opened state into locked state and vice versa is performed by a combined movement of translation and rotation. In this way, the projecting head of the connecting element can be introduced into an opening in the scaffold element and rotated inside the opening so that a positive connection is established between closure and scaffold element.

The embodiments described above all relate to a scaffold transom comprising two closures. Also disclosed is such a closure without the other components of the scaffold transom. The described embodiments of a closure are also capable of securely connecting other elements in the scaffold sector or also in other technical fields. Therefore, a closure comprising a housing and a connecting element supported so that it is movable with respect to the housing is also disclosed, the connecting element comprising at least one retaining portion and one guide portion, the retaining portion and the guide portion being disposed adjacent to each other and adjoining one another in the direction of a closure axis, the retaining portion comprising a head and a shaft disposed adjacent to each other and adjoining one another in the direction the closure axis, and the head, at least in sections, projecting beyond the shaft in the radial direction to the closure axis, the head being provided for establishing a positive connection to an element, and the closure comprising at least one clamping element which is movably, particularly positively, connected to the housing and the connecting element, a movement of the clamping element relative to the housing moving the connecting element relative to the housing in the direction of the closure axis. The embodiments disclosed in connection with the scaffold transom are also deemed disclosed in connection with the closure independent of the scaffold transom.

The object of the invention is further solved by a scaffold section comprising at least one scaffold transom according to one of the embodiments described above, further comprising
at least one scaffold element comprising a post which, at least in sections, is configured so that it is hollow in its interior, and at least one transom support interface which is attached to the post, a closure opening extending through the wall of the post being incorporated in the post in a portion in which it has a hollow configuration,
the connection interface of the scaffold transom being positively connected to the transom support interface of the scaffold element, and the closure of the scaffold transom being positively connected to the closure opening of the scaffold element, these two connection points being arranged at a distance to each other, particularly at a distance to each other in the longitudinal direction of the post.

Apart from a scaffold transom, a scaffold section according to the invention comprises at least one scaffold element which is connected to the scaffold transom through two connection points. However, the scaffold transom is preferably connected to two scaffold elements or disposed between two scaffold elements. The scaffold element may be formed, for example, by a vertical post. The scaffold element always comprises a post which, at least in sections, is configured so that it is hollow in its interior to accommodate the head of a closure of the scaffold transom. To the post, at least one transom support interface is attached which is provided for the connection of a connection interface of the transom support to a scaffold transom or a known horizontal transom. The transom support interface may be implemented, for example, as a connecting disc having accommodation openings. Furthermore, the post comprises at least one closure opening which is located in a hollow portion in a wall of the post. Alternatively, such a closure opening may also be disposed on an element of the scaffold element independent of the post. In this case, it is also possible that the post is not, in sections, implemented so that it is hollow inside. Adjacent to the closure opening, only a matching contact surface for the head of the closure has to be provided. In the preferred case in which the closure opening is incorporated in the wall of a post, it extends through the entire wall. In case of the scaffold section according to the invention, a connection interface of the scaffold transom is connected to the transom support interface of the scaffold element whereby a first connection point is formed. A second connection point is formed between the closure and the closure opening in the post of the scaffold element. This connection is established in the locked state of the closure. The connection point between the closure and the closure opening is positioned in the distance to the connection point between the connection interface of the scaffold transom and the transom support interface of the scaffold element. In this way, the scaffold transom is connected to the scaffold element by means of two spaced-apart connection points. In this way, significantly larger forces and momentums can be transferred between the scaffold transom and the scaffold element in a scaffold section according to the invention than in case of a connection of the scaffold element to a known horizontal transom. Here, the connection of the scaffold transom to the scaffold element can be established and released in an easy manner. The connection of the connection interface to the transom support interface is known and already mastered by many persons on the construction site. The closure of the scaffold transom can be operated and released in an easy manner so that this second connection point can also be established in an easy and safe manner.

In an embodiment of the scaffold section, it is contemplated that the closure opening is implemented as a long hole the longer opening width of which is oriented parallel to the longitudinal direction of the post. Such an implementation of the closure opening as a long hole is particularly suitable for the connection to the head of the closure. In the opened state of the closure, the head can be readily introduced into the slit-shaped long hole. After the rotation of the connecting element of the closure into the locked state, the head, with its portion projecting beyond the shaft, is then oriented substantially perpendicular to the longer opening width of the long hole and abuts on the inner wall of the post adjacent to the long hole. In this way, the positive connection required for the force and momentum transfer between the closure and the post is established. A closure opening in the form of a long hole can also be subsequently incorporated in existing scaffold elements in an easy manner. Such a long hole may be cut into the wall of a pole, for example, by means of an end-milling cutter. In this way, it is possible to retrofit existing scaffold elements such as, for example, vertical posts for the connection to a scaffold transom. Moreover, existing scaffold elements are sometimes already provided with suitable long holes which can be used as a closure opening.

Furthermore, it is contemplated that the head, in sections, is introduced into a hollow inner portion of the post through the closure opening, and the contact surface of the head, at least in sections, abuts on the wall in the interior of the post adjacent to the closure opening. In this embodiment, the contact surface of the head which is oriented towards the shaft abuts on the interior of the post adjacent to the boundaries of the closure opening. Here, the contact surface of the head is preferably implemented so that it is complementary in shape to the inner wall of the post. For example, if the interior of the post is formed as a circular cylinder, the contact surface of the head, at least in sections, preferably also has the shape of a circular cylinder. Here, the axes of curvature of the inner wall of the post and the contact surface of the head are preferably parallel or congruent. In such an embodiment which is complementary in shape, the head extensively abuts on the interior of the post which results in an excellent transferability of forces and momentums.

It is contemplated that, in the connection between the closure and the post, a self-contained flow of forces proceeding from the head through its contact surface to the wall of the post, from the wall of the post to the housing abutting thereon, from the housing through its clamping surface and the contact surface to the clamping element, from the clamping element through the wedge-shaped surface and the angled face to the connecting element, and inside the connecting element back to the head occurs in the locked state. In the locked state, the closure and the post are clamped to each other. For this interlock, a self-contained flow of forces is generated which flows through the post, the housing, the connecting element, and the clamping element. This flow of forces is produced by moving the clamping element into the connecting element. In the process, the partial surface slides on the angled face and thereby moves the connecting element some distance away from or out of the post again along the closure axis. The further the clamping element is introduced into the connecting element, the stronger is the interlock. With the interlock, a stable, clearance-free connection of the closure to the scaffold element is ensured.

The object of the invention is finally solved by a method for constructing a scaffold section according to one of the embodiments described above, comprising the steps of
A) transferring at least one closure of the scaffold transom into the opened state, the head plane being oriented parallel to the bracket,
B) connecting a connection interface of the transom support to a transom support interface of the scaffold element,
C) transferring the closure of the scaffold transom into the locked state, the connecting element being linearly moved toward the scaffold element along the closure axis, and the head, in sections, entering the interior of the post through the closure opening, and the connecting element then being rotated about the closure axis until the head plane is oriented substantially perpendicular to the bracket, and the clamping element then being operated, the connecting element being linearly moved away from the scaffold element along the closure axis until the contact surface of the head, at least in sections, abuts on the wall inside the post.

The method according to the invention serves the assembly of a scaffold section according to one of the embodiments described above. The method is preferably performed in the order of the process steps A) to C). However, the method may also be performed in the reverse order of the process steps to disassemble or deinstall a scaffold section.

In a first process step A), at least one closure of the scaffold transom is transferred into the opened state in which the head does not project beyond the housing. For the transfer into the opened state, the clamping element is moved within the boundaries of the operating opening so that it abuts on a side of the operating opening facing away from the bracket. In the opened state, the housing of the closure is flush with the connection interface in the direction of the longitudinal axis of the transom support.

In a second process step B), the connection interface of the transom support is positively connected to a transom support interface on the scaffold element. This connection is established like a corresponding connection of a known horizontal transom to the scaffold element. In the end of process step B), a first connection point between the connection interface and the transom support interface is already established. Here, the housing of the closure preferably already abuts on the outside of the post of the scaffold element. However, a robust connection of the closure to the scaffold element is not yet established in process step B).

In a third process step C), the closure is then transferred into the locked state. During this transfer into the locked state, first, the connecting element is moved towards the post until the head has entered the interior of the post through the closure opening. Then, or simultaneously, the connecting element is rotated about the closure axis to establish an engagement of the projecting portions of the head with the wall of the post surrounding the closure opening. The rotational movement is preferably completed when the head plane is oriented perpendicular to the bracket and perpendicular to the longer opening width of a closure opening implemented as a long hole. In this state, then, a positive connection of the closure to the post is already given: however, a clearance is still present in the connection. For establishing a non-positive connection between the closure and the post, then, the clamping element is operated by being moved into the connecting element. The connecting element is again moved some distance away from the post along the closure axis thereby until the contact surface of the head abuts on the inside of the post. In consequence of this abutment, then, a clearance does no longer exist in the connection of the closure to the scaffold element. In this way, a stable and clearance-free connection between the scaffold transom and the scaffold element is established on a second connection point. The method according to the invention can be readily performed and results in a scaffold section which has a considerably higher load capacity than a corresponding scaffold section in which a known horizontal transom is connected to a scaffold element. Owing to the design of the closure, it can always be clearly seen in which state the closure is during the method according to the invention. Particularly the position of the clamping element provides unambiguous information about whether a locked state, an opened state, or a state in between is given. Therefore, the method according to the invention reliably results in a secure connection of a scaffold transom to a scaffold element.

In an embodiment of the method, it is contemplated that, in the end of process step C), the clamping element is moved further relative to the connecting element until an interlock between the closure and the scaffold element occurs and a positive connection and a non-positive connection of the closure to the post are established. After the contact surface of the head abuts on the interior of the post in process step C), the clamping element can be moved further into the connecting element. With this further movement, the closure and the post are then clamped together, and the established non-positive connection is reinforced.

Furthermore, it is contemplated that, in the end of process step C), the contact surface of the housing abuts on an outer surface of the post, the contact surface of the clamping element abuts on the clamping surface of the housing, and the wedge-shaped surface of the clamping element abuts on the angled face of the connecting element. Preferably, the curved contact surface of the housing abuts on an outer surface of the post in the end of process step C) or at least after the establishment of an interlock between the closure and the post.

It is contemplated that, in process step C), during the operation of the clamping element, the clamping element is moved relative to the connecting element in a direction substantially perpendicular to the closure axis, and this movement is translated into a movement of the connecting element along the closure axis by the abutment of the wedge-shaped surface of the clamping element on the angled face. In process steps C), a movement of the clamping element perpendicular to the closure axis is translated into a movement of the connecting element along the closure axis. This translation is induced by the wedge-shaped surface of the clamping element sliding on the angled face of the connecting element.

In another embodiment, it is contemplated that, in the opened state of the closure, the gravity acting on the clamping element rotates the connecting element into a rotational position in which the head plane is oriented substantially parallel to the bracket, the clamping element connected to the connecting element abutting on a boundary surface of the operating opening of the housing facing away from the bracket. In this embodiment, the clamping element is configured so that it is stably held in the opened state due to gravity. This is particularly advantageous since, in this way, the connection of the closure to the scaffold element can be performed faster and more easily. During the connection of the connection interfaces to the transom support interface, the scaffold transom is usually rotated or tilted. During these movements, however, the closure is automatically and stably kept in the opened state so that, then, the head of the connecting element is correctly positioned with respect to the closure opening. In this way, the transfer of the closure into the locked state can be initiated directly after the completion process step B).

Furthermore, it is contemplated that, in process step C), the clamping element slides along the guide surface of the operating opening of the housing so that a rotational movement of the connecting element about the closure axis is induced by a linear movement of the connecting element and/or the clamping element. During the transfer of the closure from the opened state into the locked state, a linear movement of the clamping element and the connecting element along the closure axis is translated into a rotational movement of the connecting element by an interaction of the clamping element with at least one guide surface of the operating opening. This further facilitates the implementation of the method since only a linear movement into the clamping element or the connecting element has to be initiated, and the required rotational movement about the closure axis is automatically induced.

In one embodiment, it is contemplated that, in process step C), the linear movement of the connecting element along the closure axis towards the scaffold element is initiated by the introduction of a force into the force introduction surface of the connecting element. In this embodiment, the transfer from the opened state into the locked state may also, at least partly, be induced by introducing a force and a movement into the force introduction surface of the connecting element. For example, this may, in an easy manner, take place by a hammer blow being applied to the force introduction surface. In this way, the connecting element, together with the clamping element, is moved along the closure axis in the direction of the post. In this way, the transfer from the opened state into the locked state can be initiated in a fast and simple manner. Of course, it is also possible to initiate this transfer by applying a force and a movement to the clamping element.

Features, effects, and advantages disclosed in connection with the scaffold transom and the scaffold section are also deemed disclosed in connection with the method. The same applies in the reverse direction; features, effects, and advantages disclosed in connection with the method are also deemed disclosed in connection with the scaffold transom and the scaffold section.

### BRIEF DESCRIPTION OF THE DRAWINGS

In the Figures, embodiments of the invention are schematically illustrated. Here,

FIG. 1 shows a perspective view of an embodiment of a scaffold section according to the invention,

FIG. 2 shows a side view of an embodiment of a scaffold transom according to the invention,

FIG. 3 shows a side view of o a closure according to an embodiment of a scaffold transom according to the invention in the opened state,

FIG. 4 shows a cut side view of a closure according to an embodiment of a scaffold transom according to the invention in the opened state,

FIG. 5 shows a side view of a closure according to an embodiment of a scaffold transom according to the invention in the locked state,

FIG. 6 shows a cut side view of a closure according to an embodiment of a scaffold transom according to the invention in the locked state,

FIG. 7 shows a partly cut perspective view of an embodiment of a scaffold section according to the invention with a closure in the opened state,

FIG. 8 shows a partly cut perspective view of an embodiment of a scaffold section according to the invention with a closure in the locked state,

FIG. 9 shows a cut plan view of the connection between a post and a closure in the locked state.

### DETAILED DESCRIPTION

In the Figures, identical elements are designated by the same reference numerals. Generally, the described properties of an element described in connection with one Figure also apply to the other Figures. Directional information such as above or below relate to the described Figure and are to be applied to the other Figures accordingly.

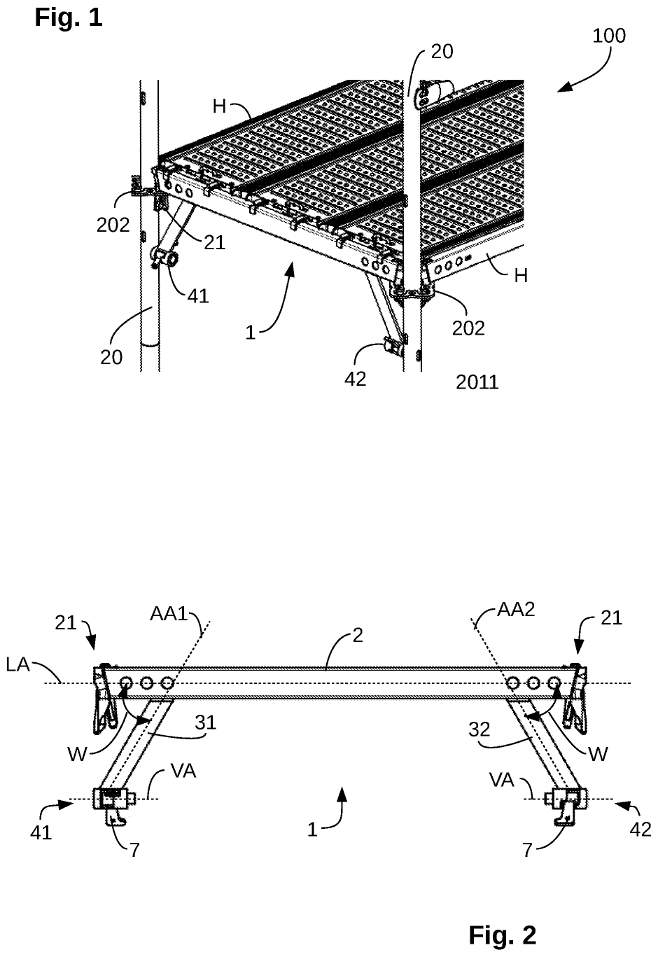

FIG. 1 shows a perspective view of an embodiment of a scaffold section 100 according to the invention. The illustrated scaffold section 100 comprises a scaffold transom 1 which is installed with its longitudinal axis LA in a horizontal orientation here. The scaffold transom 1 is illustrated in detail in and described with reference to FIG. 2. The scaffold transom 1 is connected to a scaffold element 20 formed by a vertical post here on respectively one end. On each of its ends, the scaffold transom 1 comprises two connection points to a scaffold element 20. Further up on the scaffold element 20, respectively one transom support interface 202 is disposed which is formed by a connecting disc here. On each of its ends, the scaffold transom 1 is positively connected to a transom support interface 202 of the scaffold element 20 at one of its connection interfaces 21. Below the transom support interface 202, a closure opening 2011 oriented in the direction of the interior of the scaffold section 100 is disposed on each scaffold element 20. These closure openings 2011 are concealed by respectively one closure 41 and 42 of the scaffold transom 1 in the illustration. However, a similar closure opening 2011 can be seen on the side of a scaffold element 20 facing the front right. The scaffold transom 1 is connected to a closure opening 2011 in a scaffold element 20 by means of respectively one of its closures 41 and 42. In this way, respectively two connection points exist between the scaffold transom 1 and a scaffold element 20. Owing to this connection via two connection points between the scaffold transom 1 and a scaffold element 20, considerably higher forces and momentums can be transferred between the scaffold transom 1 and the scaffold element 20. Therefore, the illustrated scaffold section 100 has a considerably higher load capacity and can withstand higher bending loads than a scaffold section in which, instead of the scaffold transom 1, a known horizontal transom is installed which is only connected to a scaffold element 20 at respectively one connection point. In the illustration, other scaffold elements can be seen. Starting from the two vertically oriented scaffold elements 20, two known horizontal transoms H which are also connected to a transom support interface 202 extend to the rear right, respectively. Placed on the scaffold transom 1 and the two horizontal transoms H, three treading layers can be seen which together form a treading plane of the scaffold section 100.

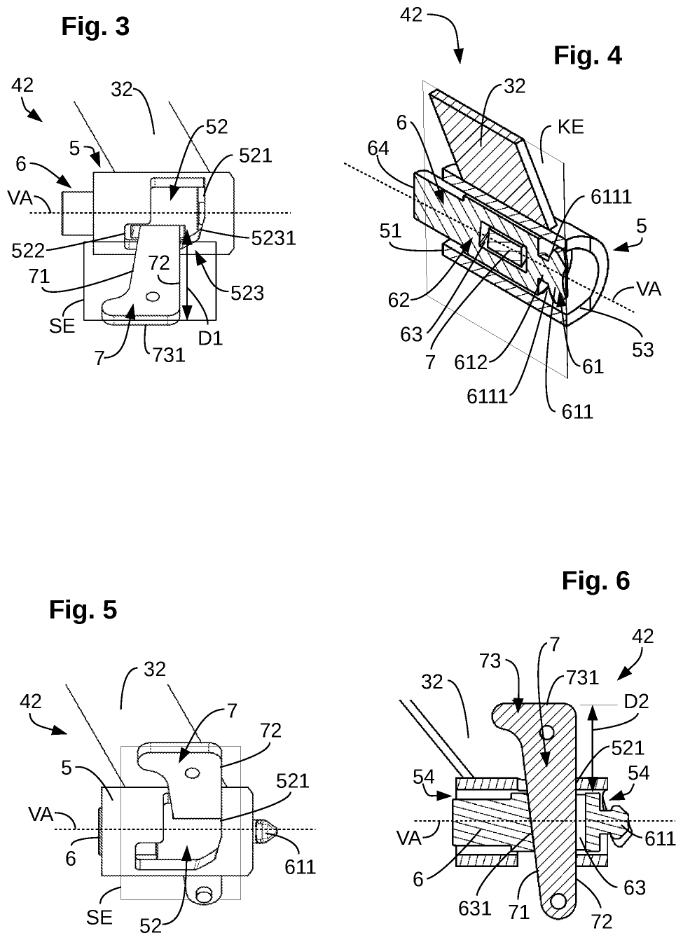

FIG. 2 shows a side view of an embodiment of a scaffold transom 1 according to the invention. FIG. 2 shows the scaffold transom 1 of FIG. 1. The scaffold transom 1 comprises a transom support 2 oriented from the left to the right in the illustration. Dieser transom support 2 is implemented in a rod-shape and formed by a pipe having a rectangular cross section here. The transom support 2 extends along a longitudinal axis LA. On the two opposite ends of the transom support 2, a connection interface 21 is disposed, respectively. Each of these connection interfaces 21 comprises two elements which are movable relative to each other. The connection interface 21 is provided for the positive connection to a scaffold element 20, for example, a vertical post. Horizontal transoms only comprised of a transom support 2 having two connection interfaces 21 disposed on its ends are known. Such horizontal transoms only comprise the two connection interfaces 21 as connection points for the connection to other scaffold elements 20. The illustrated embodiment of a scaffold transom 1 according to the invention further comprises two additional connection points formed by the two closures 41 and 42. The transom support 2 is fixedly connected to a first closure 41 by means of a first bracket 31. Furthermore, the transom support 2 is fixedly connected to a second closure 42 by means of a second bracket 32. The first bracket 31 extends along a first bracket axis AA1, the second bracket 32 extends along a second bracket axis AA2. In the illustrated embodiment, the brackets 31 and 32 are made of massive, plate-shaped elements made of an iron-based material. Alternatively, the two brackets 31 and 32 may also be formed by pipes. The brackets 31 and 32 are dimensioned so that a sufficient force and momentum transfer from the closures 41 and 42 to the transom support 2 is possible. The two bracket axes AA1 and AA2 are respectively oriented at an equally large angle W to the longitudinal axis LA. In the illustrated embodiment, the angle W is about 60°. However, the angle W may also assume other values which range from 1° to 89°. The smaller the selected angle W is, the longer the brackets 31 and 32 have to be. Each bracket 31, 32 has two opposite ends. One of these ends is connected to the transom support 2, for example, by means of a weld connection. It is also possible to implement this connection in another way, for example, as a plug-in connection or screw connection. To the second end of a bracket 31, 32, a closure 41, 42 is attached, respectively. The closure 41, 42 serves as an interface or connection point for the connection of the scaffold transom 1 to a scaffold element 20. Details on the structure and function of the closure 41, 42 are illustrated in and described with reference to FIGS. 3 to 6 and FIG. 9. The closure 41, 42 comprises a connecting element 6 which extends along a closure axis VA. The closure axis VA also defines the direction in which the connecting element 6 moves during a connection to a scaffold element 20. During such a connection of the closure 41, 42 to a scaffold element 20 by means of the connecting element 6, the connecting element 6 is first moved towards the scaffold element 20 along the closure axis VA, then rotated about the closure axis VA, and finally moved away from the scaffold element 20 again by a distance along the closure axis VA. Details on the establishment and release of the connection of the closure 41, 42 to the scaffold element 20 will be described later. The closure axis VA of the two closures 41 and 42 is oriented parallel to the longitudinal axis LA of the transom support 2. The ends the closures 41 and 42 facing outwards are flush with the connection interfaces 21 respectively disposed above them in the direction of the longitudinal axis LA. Each closure 41 and 42 comprises a clamping element 7 which can also be clearly seen in the overview in FIG. 2. The clamping element 7 serves to operate the closure 41, 42. By means of movements and forces introduced into the clamping element 7, the closure 41, 42 can be transferred from an opened state into a locked state and vice versa. In the opened state, the scaffold transom 1 can be attached to or removed from a scaffold element 20. In the locked state, the scaffold transom 1 is positively and non-positively connected to the scaffold element 20.

FIG. 3 shows a side view of a closure 42 according to an embodiment of a scaffold transom 1 according to the invention in the opened state. In FIG. 3, the closure 42 illustrated on the right side in FIG. 2 is shown in an enlarged scale. The closure 41 illustrated on the left side in FIG. 2 corresponds to the closure 42 but is implemented so that it is symmetrical to an imaginary plane located perpendicular to the longitudinal axis LA in the centre of the longitudinal axis LA. On the upper side of FIG. 3, the end of the bracket 32 facing away from the transom support 2 can be seen. The closure 42 comprises a housing 5 which is fixedly connected to the bracket 32. The housing 5 has a substantially cylindrical shape on the outside. However, the external shape of the housing may also have another design. In the interior of the housing 5, a cylindrical cavity is incorporated which extends along the closure axis VA. Details of this cylindrical cavity can be seen, for example, in the cross-sectional view in FIG. 4. Into this cylindrical cavity in the housing 5, the connecting element 6 is introduced and movably supported there. The connecting element 6 is described in detail with reference to FIG. 4. The clamping element 7 is, in sections, introduced into the connecting element 6 and the housing 5. Here, the clamping element 7 is designed so that it is symmetrical to a clamping element plane SE. The clamping element plane SE extends through the clamping element 7 in the centre of its thickness. The clamping element plane SE is an imaginary plane which facilitates the description of the interaction of the clamping element 7 with other elements of the closure 42. In a plan view of the clamping element plane SE, the clamping element has, in sections, a wedge-shaped design. This wedge shape serves to generate a clamping force in the locked state. The described wedge shape exists between the wedge-shaped surface 71 oriented towards the left in the illustration and the contact surface 72 oriented towards the right in the illustration. In a plan view of the clamping element plane SE, the wedge-shaped surface 71 and the contact surface 72 are oriented at an angle of 0.5° to 45° with respect to each other. In the illustrated embodiment, this angle is about 10°. Adjacent to the portion designed in a wedge-shape, the clamping element 7 comprises a force introduction portion 73 which is oriented towards the front in the illustration. This force introduction portion 73 comprises at least one force introduction surface 731 which is oriented perpendicular to the clamping element plane SE and perpendicular to the contact surface 72 here. The clamping element 7 can be moved into the connecting element 6 and the housing 5 by the introduction of a force into the force introduction surface 731, for example, by means of hammer blows to generate a clamping force. In the front side of the housing wall 51 of the housing 5 facing the onlooker in the illustration, an irregularly shaped operating opening 52 is incorporated. The operating opening 52 extends through the housing wall so that a part of the connecting element 6 can be seen. The clamping element 7 is introduced into the housing 5 through the operating opening 52. The operating opening 52 limits and guides the movement of the clamping element 7 positively connected to the connecting element 6 relative to the housing 5. On the side of the operating opening 52 oriented towards the right in the illustration which is located opposite of the first closure 41, there is a planar clamping surface 521 disposed perpendicular to the closure axis VA. In the locked state, the contact surface 72 of the clamping element 7 abuts on the clamping surface 521. On the side of the operating opening 52 disposed opposite of the clamping surface 521, a likewise planar boundary surface 522 is disposed. In the illustrated opened state, this boundary surface 522 limits the movement of the clamping element 7 in the direction towards the first closure 41. It can be clearly seen that, when the clamping element 7 is moved further towards the left in the illustration together with the connecting element 6, the wedge-shaped surface 71 abuts on the boundary surface 522 whereby this movement is limited. The operating opening 52 is, in sections, further defined by a slide portion 523. This slide portion 523 connects the clamping surface 521 to the boundary surface 522 and extends on the right and on the lower side of the limitation opening 52 in the illustration. In the illustration, the clamping element 7, in sections, abuts on the slide portion 523 on its lower side. The slide portion 523 comprises at least one guide surface 5231 arranged at an angle to the clamping surface 521. In the illustrated embodiment, the guide surface 5231 comprises two partial surfaces which are oriented at different angles to the clamping surface 521. The guide surface 5231 has the function of generating a rotational movement of the connecting element 6, together with the clamping element 7, about the closure axis VA from a linear movement introduced on the clamping element 7 in the direction of the closure axis VA. When the clamping element 7 is moved towards the right in the direction of the closure axis VA starting from the position illustrated in FIG. 3 the contact surface 72 slides along the slide portion 523 and the guide surface 5231. In this way, the clamping element 7 is rotated upwards about the closure axis VA and guided towards the clamping surface 521. The angle assumed by the guide surface 5231 relative to the clamping surface 521 influences the degree to which a linear movement of the clamping element 7 is translated into a rotational movement. The slide portion 523 serves a facilitated operability of the closure 42. For transferring the closure 42 from the opened state into the locked state, only a linear movement in the direction of the closure axis VA has to be introduced into the clamping element 7 which may be implemented, for example, by a hammer blow onto the force introduction portion 73. In this way, the rotational movement about the closure axis VA also required for assuming the locked state is automatically generated. The operation of the closure 42 is thus easy and can be reliably performed even by untrained staff. In the illustrated opened state of the closure 42, the clamping element 7 projects beyond the connecting element 6 by a first distance D1. This first distance D1 extends from the outer surface of the shown cylindrical portion of the connecting element 6 to the force introduction surface 731. This distance D1 from the force introduction surface 731 to the surface of the connecting element 6 is larger in the opened state than a corresponding second distance D2 in the locked state.

FIG. 4 shows a cut side view of a closure 42 according to an embodiment of a scaffold transom 1 according to the invention in the opened state. In FIG. 4, the state of FIG. 3 is illustrated in a cross section. The sectional plane extends in the centre of the bracket 32 in the direction of the thickness and bisects the closure 42. In this cross-sectional view, the shape of the connecting element 6 can be clearly seen. The connecting element 6 comprises a retaining portion 61 oriented towards the front right and including a head 611 and a shaft 612. Adjacent to the retaining portion 61, a guide portion 62 is disposed which, in sections, has a cylindrically shaped outer surface. The connecting element 6 is supported between the cylindrically shaped outer surface of the guide portion 62 and a cylindrical surface of a cavity in the housing 5 facing inwards by means of a plain bearing. Here, a clearance fit between the guide portion 62 and the cylindrical cavity in the housing 5 is given. In this way, the connecting element 6 is shiftable in the interior of the housing 5 along the closure axis VA and rotatable about the closure axis VA. The connecting element 6 is altogether longer than the housing 5 in the direction of the closure axis VA. Therefore, the connecting element 6 will always project beyond the housing 5 on one side. In the guide portion 62, a clamping element receptacle 63 is incorporated. This clamping element receptacle 63 extends through the guide portion 62 in the radial direction and intersects the closure axis VA. The cross-sectional area of the clamping element receptacle 63 has a rectangular design in the illustrated cross-sectional view. Here, this cross-sectional area varies in size in the radial direction to the closure axis. This can be clearly seen in another cross-sectional view in another sectional plane in FIG. 6. On its side facing away from the connection portion 61, the guide portion 62 comprises a force introduction surface 64 which is oriented perpendicular to the closure axis VA here. This force introduction surface 64 may be used, for example, to move the connecting element 6 relative to the housing 5 by introducing a force in the direction of the closure axis VA, for example, by means of hammer blows. The shaft 612 directly adjoins the guide portion 62 and is configured so that it is cylindrical and symmetrical to the closure axis VA here. The shaft 612 connects the guide portion 62 to the head 611. In the illustrated embodiment, the head 611 projects beyond the shaft 612 in two opposite directions perpendicular to the closure axis VA. For facilitating the description of the head 611, an imaginary head plane KE is defined. This head plane KE extends parallel to the closure axis VA and bisects the guide portion 62 in the radial direction. The head plane KE intersects the head 611 so that it is formed symmetrical to the head plane KE in the direction of its thickness. The head 611 comprises a curved contact surface 6111 which faces the guide portion 62. In the cross-sectional view which also extends along the head plane KE, it can be seen that, in the illustrated embodiment, the contact surface 6111 is comprised of two subsections which are disposed opposite to each other with respect to the closure axis. In the illustrated embodiment, the head 611 is therefore implemented so that it is symmetrical to the closure axis VA in the head plane KE. This serves a uniform transfer of forces between the head 611 and a scaffold element 20 which can be clearly seen in FIG. 9. Preferably, the curved contact surface 6111, at least in sections, constitutes part a circumferential surface of a circular cylinder. Owing to this design, an extensive abutment of the contact surface 6111 to a likewise circular cylinder-shaped inner surface of a scaffold element 20 is given. The central axis of the circular cylinder defining the shape of the curved contact surface 6111 extends perpendicular to the head plane KE. Between the head 611 and the guide portion 62, adjacent to the shaft 612, an undercut is disposed which can be used for establishing a positive connection of the connecting element 6 to a scaffold element 20. In a plane perpendicular to the head plane KE, the head 611 is pointed. This means that the head 611 is tapered in this plane in the direction of the closure axis VA on the side of the connecting element 6 facing away from the opposing closure 41. Owing to this tapered shape, the insertion of the head 611 into a closure opening 2011 of a scaffold element 20 is facilitated. The thickness of the head 611 perpendicular to the head plane KE is thinner than the diameter of the cylindrical portion of the guide portion 62. In the illustrated embodiment, the head 611 comprises two outer boundaries extending parallel to each other in a plane perpendicular to the head plane KE and perpendicular to the closure axis VA. In this way, the head 611 can be introduced into a closure opening 2011 implemented as a long hole. In the illustrated embodiment, the clamping element receptacle 63, at least in sections, extends perpendicular to the head plane KE. However, the direction of extension of the clamping element receptacle 63 may also extend other than perpendicular, particularly rotated with respect to the head plane. On its two opposite ends in the direction of the closure axis, the housing 5 has respectively one opening 54 which is implemented so that it is circular here. In this way, the connecting element 6 can be introduced and removed from both sides of the housing 5. On its side facing away from the closure 41 in the direction of the closure axis VA, the housing 5 comprises a curved contact surface 53. When the scaffold transom 1 is connected to a scaffold element 20 the contact surface 53 abuts on an outer surface of the scaffold element 1. Preferably, this outer surface of the scaffold element 20 is a cylindrically implemented circumferential surface. Due to the fact that the contact surface 53 is also curved, preferably cylindrically curved, an extensive, uniform abutment of the scaffold transom 1 on the scaffold element 20 is provided for which is capable of transferring large forces and momentums. The axis of curvature of the curvature of the contact surface 53 extends perpendicular to the closure axis VA and parallel to the bracket 32.

FIG. 5 shows a side view of a closure 42 according to an embodiment of a scaffold transom 1 according to the invention in the locked state. In FIG. 5, the closure 42 of FIGS. 3 and 4 can be seen which, however, is in the locked state in FIG. 5. In the locked state, the head 611 projects beyond the housing 5 of the closure 42. The force introduction surface 64 of the connecting element 6 projects only slightly on the side of the housing 5 facing away from the head 611 now. The contact surface 72 of the clamping element 7 abuts on the clamping surface 521. For transferring the closure 42 from the opened state shown in FIG. 3 into the locked state shown in FIG. 5, the clamping element 7, together with the connecting element 6, was, on the one hand, moved linearly away from the closure 41 along the closure axis, and, on the other hand, rotated about the closure axis VA in a direction from the bottom to the top in the illustration. The end of this rotational movement is limited by the surface of the clamping element 7 facing upwards abutting on the boundary surface of the operating opening 52 oriented perpendicular to the clamping surface 521 and facing the bracket 32. Due to this abutment, reaching the locked state is clearly defined and haptically tangible. In this way, operating the closure 42 is easy, and it is ensured that the closure 42 is connected to a scaffold element 20. The last step in the transfer from the opened state into the locked state is a linear movement or operation of the clamping element 7 into the clamping element receptacle 63. With this movement, an interlock between the head 611 and a scaffold element 20 is established. Details on this clamping movement are described with reference to FIG. 6 and FIG. 9. On the end of the clamping element 7 facing downwards in the illustration, a locking pin can be seen which extends through the clamping element 7 perpendicular to the clamping element plane SE. This locking pin has the effect that the clamping element 7 will not fall out of the clamping element receptacle 63 in the opened state shown in FIG. 3. The side of the clamping element 7 facing the onlooker in FIG. 3 on which the force introduction surface 731 is disposed has a larger weight than the side on which the locking pin is inserted. In this way, in the opened state shown in FIG. 3, the gravity acting on the clamping element 7 has the effect that the clamping element 7, together with the connecting element 6, is automatically rotated into a rotational position corresponding to the opened state. The gravity on the side of the clamping element 7 on which the force introduction surface 731 is disposed has the effect that the clamping element 7 abuts on the lateral surface of the operating opening 52 disposed between the boundary surface 522 and the guide surface 521 so that the rotational position is clearly defined in the opened state. This automatic alignment of the clamping element 7 and the connecting element 6 ensures an easy introduction of the head 611 into a closure opening 2011 of a scaffold element 20.

FIG. 6 shows a cut side view of a closure 42 according to an embodiment of a scaffold transom 1 according to the invention in the locked state. In FIG. 6, a cross-sectional view of the locked state illustrated in FIG. 5 is shown in a sectional plane extending through the clamping element plane SE. In this cross-sectional view, the interaction of the housing 5, the connecting element 6, and the clamping element 7 can be clearly seen. The wedge-shaped surface 71 of the clamping element 7 abuts on the angled face 631 of the clamping element receptacle 63. The contact surface 72 of the clamping element abuts on the clamping surface 521 of the housing 5. The clamping element 7 projects beyond the connecting element 6 by a second distance D2, the second distance D2 being defined between the outer surface of the cylindrical portion of the guide portion 62 and the force introduction surface 731. The second distance D2 is smaller than the first distance D1 illustrated in FIG. 3, and the clamping element 7 is inserted further into the clamping element receptacle 63 in the locked state than in the opened state. The clamping element 7 is slidably supported in the clamping element receptacle 63. When the clamping element 7, starting from the state illustrated in FIG. 6, is moved further into the connecting element 6 in a direction perpendicular to the closure axis VA the wedge-shaped surface 71 slides along the angled face 631. In this way, a movement of the clamping element 7 perpendicular to the closure axis VA is translated into a movement of the connecting element 6 along closure axis VA. In this way, the interlock between the closure 42 and a scaffold element 20 can be enhanced or adjusted by the introduction of a force into the force introduction surface 731, for example, by hammer blows.

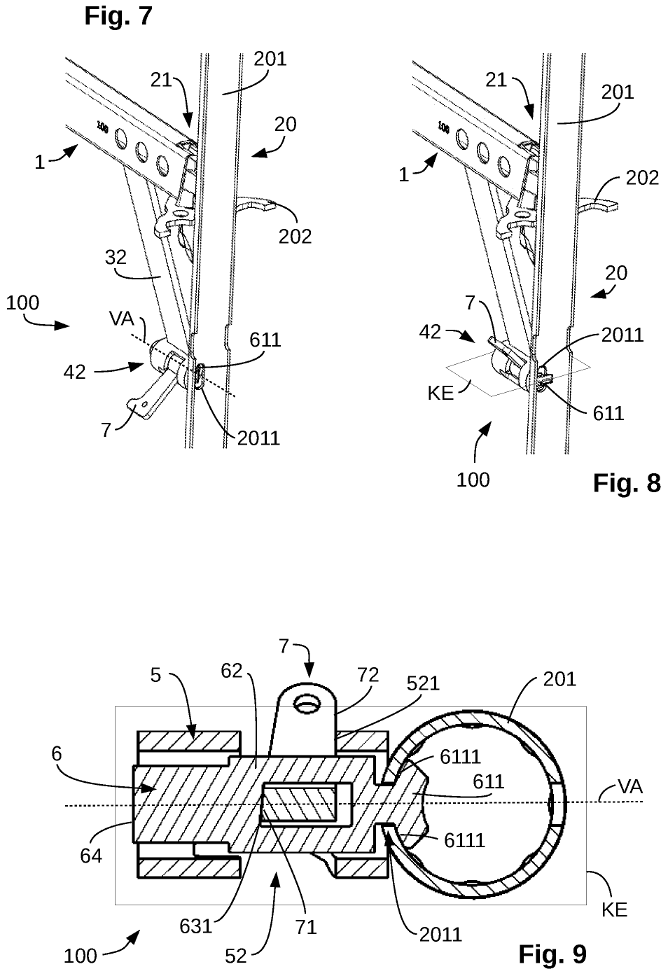

FIG. 7 shows a partly cut perspective view of an embodiment of a scaffold section 100 according to the invention comprising a closure 42 in the opened state. The scaffold section 100 comprises a scaffold transom 1 according to the embodiment illustrated in FIG. 2 to FIG. 6. The scaffold section 100 further comprises a scaffold element 20 which is implemented as vertical post here. The scaffold element 20 comprises a vertically oriented post 201. This post 201 is illustrated in a cross section in the illustration so that the interior of the post 201 can be seen. The post 201 is formed by a cylindrical pipe here which, in its interior, is implemented so that it is hollow over the entire length. To the post 201, a transom support interface 202 implemented as a connecting disc here is attached. The transom support interface 202 is also illustrated in the cross section. In the state illustrated in FIG. 7, the connection interface 21 of the scaffold transom 1 is already positively connected to an opening in the transom support interface. The scaffold transom 1 is therefore already connected to the scaffold element 20 via one connection point. Below the transom support interface 202, a closure opening 2011 extending through the wall of the post 201 is incorporated in the wall of the post 201. The closure opening 2011 is implemented as long hole, the longer side or opening width of the long hole extending along the longitudinal direction of the post 201. In the state shown in FIG. 7, the closure 42 of the scaffold transom 1 is in the opened state illustrated in FIG. 3 and FIG. 4. It can be seen that the head 611 is positioned and oriented relative closure opening 2011 so that it can be inserted into the hollow interior of the post 201 through the closure opening 2011 along the closure axis VA. Starting from the opened state illustrated in FIG. 7, the closure 42 can be transferred into the locked state illustrated in FIG. 8. The insertion of the head 611 into the interior of the post 201 may take place, for example, by the clamping element 7 being manually moved along the closure axis VA. Alternatively, also a force acting along the closure axis VA can be introduced into the connecting element 6 via the force introduction surface 64, for example, by means of hammer blows.

FIG. 8 shows a partly cut perspective view of an embodiment of a scaffold section 100 according to the invention including a closure 42 in the locked state. FIG. 8 shows the scaffold section 100 of FIG. 7, the closure 42 having been transferred into the locked state. The head 611 is positioned in the hollow interior of the post 201. The closure 42 and the post 201 of the scaffold element 20 are positively and non-positively connected to each other. The illustrated portion of a scaffold section 100 therefore comprises two connection points between the scaffold transom 1 and the scaffold element 20 now, a first connection point between the connection interface 21 on the transom support 2 and the transom support interface 202, as well as a second connection point between the closure 42 and the closure opening 2011. Starting from the opened state illustrated in FIG. 7, the connecting element 6, together with the clamping element 7, was first linearly moved towards the scaffold element 20 along the closure axis, the head 611 having entered the post 201 through the closure opening 2011. Then, or together with this linear movement, the connecting element 6 and the clamping element 7 were rotated by 90° about the closure axis VA. In the end of the rotational movement, the head plane KE is oriented substantially perpendicular to the bracket 32. In a last step, the clamping element 7 was operated by being inserted further into the locking element 6. With this insertion of the clamping element 7, the connecting element 6 was again moved away from the scaffold element 20 by some distance along the closure axis VA. Due to this operation of the clamping element 7, the curved contact surface 6111 of the head 611 abuts on the interior of the post 2011 adjacent to the closure opening 2011 in the illustrated state. This state can be seen in the cross section in a plan view in FIG. 9.

FIG. 9 shows a cut plan view of the connection between a post 201 and a closure 42 in the locked state. In FIG. 9, the locked state of FIG. 8 can be seen. The view shows a sectional view in the head plane KE. The head 611 is positioned in the interior of the post 201 and abuts on the wall in the interior of the post 201 with its curved contact surface 6111. The radius of curvature of the contact surface 6111 is configured so that it is identical to the radius of curvature of the inner wall of the post 201 so that an extensive contact surface between closure 42 and scaffold element 20 is provided for. In the illustrated state, the closure 42 and the post 201 are clamped together. This interlock was established by an operation of the clamping element 7. In the illustrated state, owing to the interlock, a closed flow of forces prevails between the closure 42 and the scaffold element 20. This flow of forces first proceeds from the head 611 through the contact surface 611 to the inner wall of the post 201. The flow of forces then further proceeds from the outer wall of the post 201 through the contact surface 53 of the housing 5 into the housing 5. The contact surface 53 in the sectional plane cannot be seen in FIG. 9. From the housing 5, the flow of forces further proceeds through the clamping surface 521 and the contact surface 72 in the clamping element 7 abutting thereon. From the clamping element 7, the flow of forces further proceeds through the partial surface 71 and the angled face 631 abutting thereon to the connecting element 6. Finally, the flow of forces is closed within the connecting element 6 and proceeds further through the guide portion 62 and the shaft 612 back to the head 611. The illustrated positive and non-positive connection between the closure 42 and the post 201 in the locked state is stable and reliable and renders the transfer of forces and momentums possible. For removing the closure 42 from post 201, the steps for establishing this connection described with reference to FIG. 7 to FIG. 9 are simply to be performed in the reverse order.

### LIST OF REFERENCE NUMERALS

1 Scaffold transom
2 Transom support
21 Connection interface
31, 32 Brackets
41, 42 Closure
5 Housing
51 Housing wall
52 Operating opening
521 Clamping surface
522 Boundary surface
523 Slide portion
5231 Guide surface
53 Contact surface
54 Opening
6 Connecting element
61 Retaining portion
611 Head
6111 Contact surface
612 Shaft
62 Guide portion
63 Clamping element receptacle
631 Angled face
64 Force introduction surface
7 Clamping element
71 Clamping surface
72 Contact surface
73 Force introduction portion
731 Force introduction surface
20 Scaffold element
201 Post
2011 Closure opening
202 Transom support interface
AA1, AA2 Bracket axis
D1 First distance
D2 Second distance
H Horizontal transom
LA Longitudinal axis
VA Closure axis
SE Clamping element plane
KE Head plane
W Angle

1. A scaffold transom, comprising:
at least one transom support, which is rod-shaped and extends in the direction of a longitudinal axis, wherein the transom support has two opposing ends in the direction of the longitudinal axis, and a connection interface is located at each of these two ends which connection interface is provided for the connection to a scaffold element,
at least two brackets which each extend along a bracket axis, wherein the bracket axes are respectively oriented at an angle of 1° to 89° to the longitudinal axis, and wherein the brackets respectively have two opposing ends in the direction of their bracket axis, wherein one of these ends of each bracket is connected to the transom support,
at least two closures, respectively one of which is located at the end of a bracket opposite of the connection of said bracket to the transom support,
wherein each closure comprises a housing fixedly connected to the bracket, and each closure further comprises a connecting element supported so that it is movable with respect to the housing,
wherein the connecting element comprises at least one retaining portion and one guide portion, wherein the retaining portion and the guide portion are arranged adjacent to each other and adjoining one another in the direction of a closure axis, wherein the retaining portion comprises a head and a shaft which are disposed adjacent to each other and adjoining one another in the direction of the closure axis, and the head, at least in sections, projects beyond the shaft in the radial direction to the closure axis, wherein the head is provided for establishing a positive connection to a scaffold element, and wherein each closure comprises at least one clamping element which is movably, connected to the housing and the connecting element, wherein a movement of the clamping element relative to the housing moves the connecting element relative to the housing in the direction of the closure axis, wherein the two connection interfaces of the at least one transom support and the two closures together provide for at least four connection points for the connection of the scaffold transom to other scaffold elements, and the connection interfaces are different from the closures with respect to the shape and the size.

2. The scaffold transom according to claim 1, wherein the closure axis is oriented parallel to the longitudinal axis, and/or the guide portion, at least in sections, has a cylindrical configuration, and in the housing, at least in sections, a cylindrical cavity is incorporated, wherein the inner diameter of the cylindrical cavity is larger than the outer diameter of the cylindrical section of the guide portion, and a clearance fit prevails between the cylindrical cavity and the guide portion, and the connecting element, at least in sections, is positioned inside the housing.

3. The scaffold transom according to claim 1, wherein a clamping element receptacle implemented as an opening extending through the guide portion in the radial direction to the closure axis is incorporated in the guide portion.

4. The scaffold transom according to claim 1, wherein the head comprises a curved contact surface facing the guide portion in its portion projecting beyond the shaft, and the connecting element has an imaginary head plane which extends along the closure axis and bisects the guide portion, wherein the head projects beyond the shaft on both sides of the closure axis in the head plane, and the head is formed so that it is symmetrical to the head plane.

5. The scaffold transom according to claim 3, wherein the clamping element receptacle comprises at least one angled face which is oriented at an angle of 0.5° to 45° to a plane which is oriented perpendicular to the closure axis, and the clamping element comprises an imaginary clamping element plane, wherein the clamping element plane extends through the clamping element, wherein the clamping element is particularly designed so that it is symmetrical to the clamping element plane in the direction of the thickness, wherein the clamping element, at least in sections, has a wedge shape in a plan view of the clamping element plane and comprises a wedge-shaped surface defining the clamping element perpendicular to the clamping element plane, and the clamping element further comprises a contact surface defining the clamping element perpendicular to the clamping element plane on a side opposite of the wedge-shaped surface, wherein the clamping surface is oriented at an angle of 0.5° to 45° to the contact surface.

6. The scaffold transom according to claim 1, wherein the housing, in its housing wall defining the, at least in sections, cylindrically implemented cavity, comprises an operating opening extending through the housing wall, wherein the operating opening comprises at least one clamping surface which is oriented perpendicular to the closure axis and which defines the operating opening in the direction of the closure axis on the side facing away from the second closure.

7. The scaffold transom according to claim 6, wherein the operating opening comprises a slide portion which is part of the boundary of the operating opening, wherein the slide portion connects the clamping surface to the boundary surface, wherein the slide portion comprises at least one guide surface which is oriented at an angle of 1° to 89° to the clamping surface, wherein the guide surface is disposed on the side of the operating opening disposed opposite of the connection of the housing to the bracket.

8. The scaffold transom according to claim 6, wherein the clamping element, at least in sections, is introduced into the housing and the connecting element, wherein the clamping element extends through the operating opening and the clamping element receptacle, and the wedge-shaped surface is oriented parallel to the angled face, and the contact surface is oriented parallel to the clamping surface.

9. The scaffold transom according to claim 4, wherein an opened state of the closure is provided in which the head is disposed in the interior of the housing, the head plane is oriented substantially parallel to the bracket, and the clamping element projects beyond the connecting element by a first distance, wherein the first distance is the distance between the outer surface of the cylindrical section of the guide portion and the force introduction surface, and a locked state of the closure is provided in which the head projects beyond the housing, the head plane is oriented substantially perpendicular to the bracket, the wedge-shaped surface abuts on the angled face, the contact surface abuts on the clamping surface, and the clamping element projects beyond the connecting element by a second distance, wherein the second distance is the distance between the outer surface of the cylindrical section of the guide portion and the force introduction surface, wherein the second distance is smaller than the first distance.

10. A scaffold section comprising at least one scaffold transom according to claim 1, further comprising:
at least one scaffold element comprising a post which, at least in sections, is designed so that it is hollow is in its interior, and at least one transom support interface which is attached to the post, wherein a closure opening extending through the wall of the post is incorporated in the post in a portion in which it has a hollow configuration,
wherein the connection interface of the scaffold transom is positively connected to the transom support interface of the scaffold element, and the closure of the scaffold transom is positively connected to the closure opening of the scaffold element, wherein these two connection points are disposed at a distance to each other, particularly at a distance to each other in the longitudinal direction of the post.

11. The scaffold section according to claim 1, wherein the head, in sections, is introduced into a hollow inner portion of the post through the closure opening, and the contact surface of the head, at least in sections, abuts on the wall in the interior of the post adjacent to the closure opening, and, in the connection of the closure to the post, a self-contained flow of forces prevails in the locked state which proceeds from the head through its contact surface to the wall of the post, from the wall of the post to the housing abutting thereon, from the housing through its clamping surface and the contact surface to the clamping element, from the clamping element through its wedge-shaped surface and the angled face to the connecting element, and within the connecting element back to the head.

12. A method for constructing a scaffold section according to claim 10, comprising the steps of:
A) transferring at least of a closure of the scaffold transom into the opened state, wherein the head plane is oriented parallel to the brackets,
B) connecting a connection interface of the transom support to a transom support interface of the scaffold element,
C) transferring the closure of the scaffold transom into the locked state, wherein the connecting element is linearly moved towards the scaffold element along the closure axis, and the head, in sections, enters the interior of the post through the closure opening, and the connecting element is then rotated about the closure axis until the head plane is oriented substantially perpendicular to the bracket, and then the clamping element is operated, wherein the connecting element is linearly moved away from the scaffold element along the closure axis until the contact surface of the head, at least in sections, abuts on the wall in the interior of the post.

13. The method according to claim 12, wherein, in process step C), the clamping element slides along the guide surface of the operating opening of the housing whereby a rotational movement of the connecting element about the closure axis is produced by a linear movement of the connecting element and/or of the clamping element.

14. The scaffold transom according to claim 1, wherein the scaffold transom is for horizontally oriented installation in a scaffold section.

15. The scaffold transom according to claim 1, wherein the at least one clamping element is positively connected to the housing and the connecting element.
